(19) United States
(12) Patent Application Publication
(10) Pub. No.: US 2014/0043467 A1
(43) Pub. Date: Feb. 13, 2014

(54) DEFECT INSPECTION APPARATUS

(71) Applicant: KABUSHIKI KAISHA TOSHIBA, Tokyo (JP)

(72) Inventor: Kyoji YAMASHITA, Yokohama-shi (JP)

(73) Assignee: Kabushiki Kaisha Toshiba, Tokyo (JP)

(21) Appl. No.: 13/804,764

(22) Filed: Mar. 14, 2013

(30) Foreign Application Priority Data
Aug. 10, 2012 (JP) 2012-178052

(51) Int. Cl. H04N 7/18

(52) U.S. Cl. CPC H04N 7/18
USPC 348/125

(57) ABSTRACT

According to one embodiment, a defect inspection apparatus includes an inspection unit configured to acquire a plurality of inspection images by photographing repetitive patterns of not larger than a resolution limit of an optical system under different optical conditions with respect to a to-be-inspected sample, an edge image extraction unit configured to respectively extract edge images from the plural inspection images, and a defect determination unit configured to determine the presence of a defect of the pattern based on the plural edge images.

### CROSS-REFERENCE TO RELATED APPLICATIONS

This application is based upon and claims the benefit of priority from Japanese Patent Application No. 2012-178052, filed Aug. 10, 2012, the entire contents of which are incorporated herein by reference.

### FIELD

Embodiments described herein relate generally to a defect inspection apparatus used for defect inspection of a nano-imprinting template or the like.

### BACKGROUND

In the defect inspection of a nano-imprinting template, the pattern of the template cannot be resolved since the pattern of the template is equal magnification to a wafer and exceeds optical resolving power of the inspection apparatus. Base noise is present in an inspection image because of non-uniformity of the template due to a drawing process. The non-uniformity of the template caused by the drawing process indicates line-edge roughness occurring in electron beam drawing, development and etching.

The non-uniformity of the template caused by the drawing process increases the number of pseudo-defects when viewed from the inspection apparatus side and degrades the detection sensitivity. However, in the nano-imprinting process, the non-uniformity does not always develop into a fatal defect. The fatal defect is classified into a short defect or open defect and may give a great influence to the operation of a device. Therefore, in an inspection of a nano-imprinting template, it is required to detect a fatal defect while permitting base noise.

In a mask defect inspection for the present optical lithography, die-to-die comparison and die-to-database comparison methods are provided. The above methods are to align two dies and specify a non-coincident portion as a defect. However, in the nano-imprinting template, it is difficult to detect a fatal defect simply by die-to-die comparison because of the presence of base noise due mainly to the template drawing process as well as because of the defect signal being small in the operation of comparing the dies with each other.

As another inspection system, a characteristic extraction system in which a defect is detected by extracting the characteristic of a defect is provided. In this system, the apparatus configuration can be made simple, but it becomes sometimes difficult to apply the system depending on a pattern. Further, as still another inspection system, a method for detecting edge roughness based on the spectral characteristics due to multi-wavelength, pattern inspection method by use of an electron beam and the like are provided. However, since the above methods are not sufficient in the detection sensitivity and detection time, it is difficult to actually apply the above method to an inspection of the nano-imprinting template.

### BRIEF DESCRIPTION OF THE DRAWINGS

FIG. 1 is a block diagram showing the schematic configuration of a defect inspection apparatus according to a first embodiment.

FIG. 2 is a diagram showing one example of an inspection mechanism used in the defect inspection apparatus of FIG. 1.

FIG. 3 is a schematic view for illustrating inspection stripes set on a sample.

FIGS. 4A, 4B are views showing the configurations of an optical illumination system in the inspection mechanism.

FIGS. 5A, 5B are schematic views showing the relationship between open/short defects of nano-imprinting templates and input images.

FIGS. 6A to 6C are schematic views showing the difference between the defect of a nano-imprinting template and a variation in base noise.

FIG. 7 is a flowchart for illustrating the operation of a defect inspection apparatus according to a second embodiment.

FIGS. 8A to 8C are schematic views showing the effect of emphasizing a defect signal while reducing base noise, for illustrating the effect of the second embodiment.

FIGS. 9A, 9B are schematic views showing images obtained before and after application of a filter, for illustrating the effect of the second embodiment.

FIG. 10 is a flowchart for illustrating the operation of a defect inspection apparatus according to a third embodiment.

FIGS. 11A to 11C are schematic views showing the effect of removing a peripheral pattern, for illustrating the effect of the third embodiment.

### DETAILED DESCRIPTION

In general, according to one embodiment, a defect inspection apparatus comprises an inspection unit configured to acquire a plurality of inspection images by photographing repetitive patterns with a resolution limit of an optical system or less under different optical conditions with respect to a to-be-inspected sample, an edge image extraction unit configured to extract edge images from the plural inspection images, and a defect determination unit configured to determine the presence of a defect of the pattern based on the plural edge images.

A defect inspection apparatus of the present embodiment is explained below with reference to the drawings.

### First Embodiment

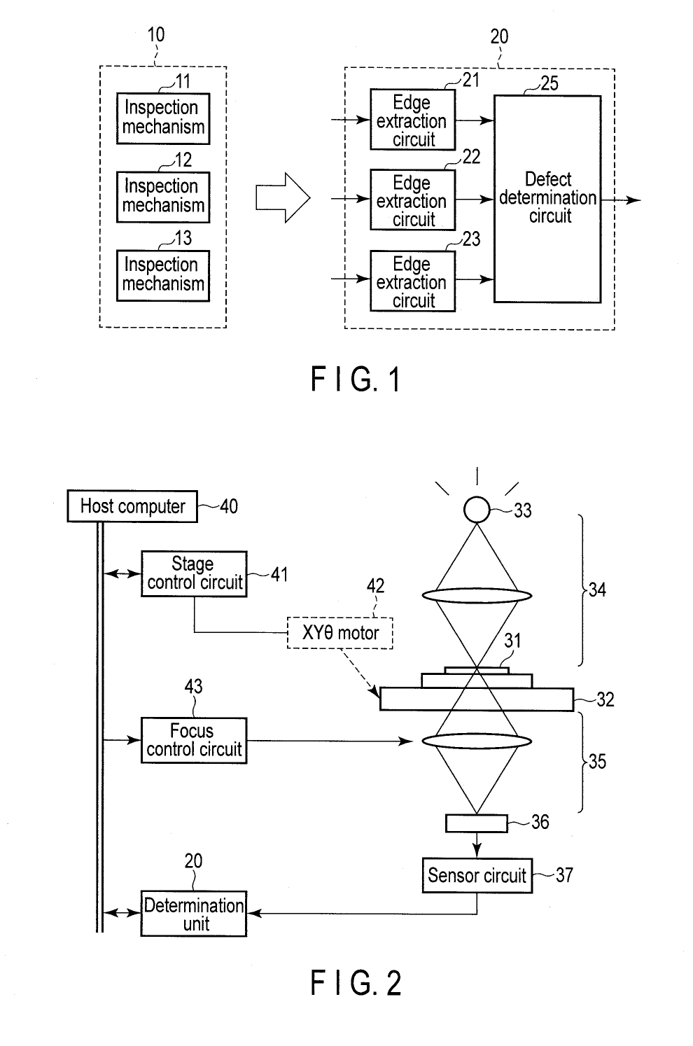

FIG. 1 is a block diagram showing the schematic configuration of a defect inspection apparatus according to a first embodiment.

The inspection apparatus of the present embodiment includes an inspection unit 10 that inspects a pattern on a sample under a plurality of different optical conditions, and a determination unit 20 that determines the presence or absence of a defect of the pattern based on a plurality of inspection images obtained in the inspection unit 10.

The inspection unit 10 includes a plurality of inspection mechanisms 11 to 13 having different optical conditions. The inspection mechanisms themselves are not limited at all and one example thereof is shown in FIG. 2.

In FIG. 2, a sample 31 is a nano-imprinting master template or the replica thereof. The sample 31 is placed on an XYθ table 32 that is provided to be movable in the horizontal direction and rotating direction. Light is applied to a pattern formed on the sample 31 by means of a light source 33 such as a DUV (ultraviolet) laser and an illumination optical system 34.

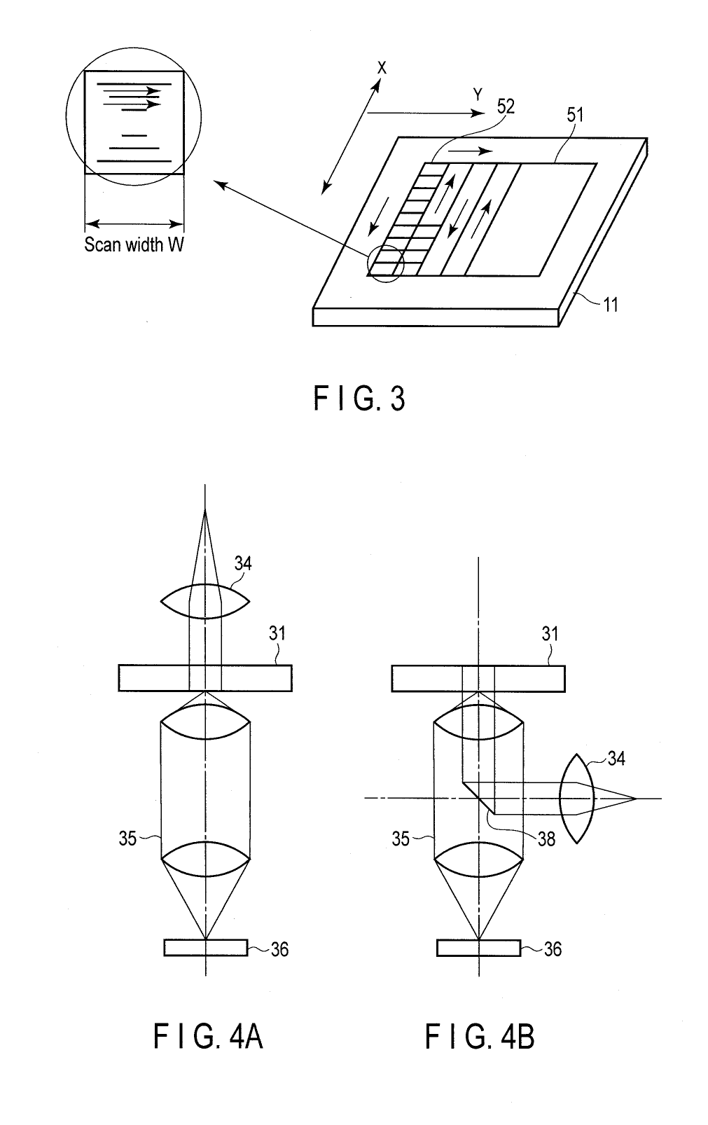

With this apparatus, as shown in FIG. 3, a to-be-inspected region 51 in which the pattern formed on the sample 31 is present is virtually divided into strip-form inspection stripes 52 with width W. Further, an inspection is made by controlling the operation of the XYθ table 32 to continuously scan the divided inspection stripes 52.

Light passing through the sample 31 is made incident on a photodiode array (imaging sensor) 36 via an image-forming optical system 35. Then, as shown in FIG. 3, an image of a portion of the strip-form regions of the pattern virtually divided is formed on the photodiode array 36 as an optical image enlarged by the image-forming optical system 35. As the photodiode array 36, a line sensor, CCD image sensing element or the like can be used.

The image of the pattern formed on the photodiode array 36 is photoelectrically converted by the photodiode array 36 and subjected to image processing by means of a sensor circuit 37 to obtain an inspection image. The inspection image is supplied to a determination unit 20. Then, the presence or absence of a defect of the pattern on the sample 31 is determined by extracting an edge of the inspection image by means of the determination unit 20.

The table 32 is controlled by means of a host computer 40. That is, the table 32 can be moved to a desired position by controlling an XYθ table 42 by means of a stage control circuit 41 under the control of the host computer 40. Further, the image-forming optical system 35 controls the focus with respect to the sample 31 by means of a focus control circuit 43 under the control of the host computer 40. Also, the sample 31 on the table 32 is carried from an autoloader (not shown).

As explained before, the inspection unit 10 includes a plurality of inspection mechanisms 11 to 13 whose optical conditions are different, but various types of mechanisms are provided as the inspection mechanisms with different optical conditions.

For example, a transmission illumination optical system as shown in FIG. 4A and a reflection illumination optical system as shown in FIG. 4B may be used to make the optical conditions of the inspection mechanisms different. Symbols 31 to 36 in the drawing denote the same portions as those of FIGS. 1 and 38 indicates a half-mirror that reflects incident light from the light source side and transmits reflection light from the sample side.

An inspection mechanism of a circular polarization illumination optical system and an inspection mechanism of a linear polarization illumination optical system may be used to make the optical conditions of the inspection mechanisms different. Further, an inspection mechanism of a bright-field illumination optical system and an inspection mechanism of a dark-field illumination optical system may be used. It is desirable to use a bright-field illumination optical system by reflection illumination to input an inspection image with high contrast.

As another example of making the optical conditions of the inspection mechanisms different, a plurality of optical system in which sigma ratios and focus shift amounts of different illumination optical systems are set may be used. That is, a plurality of inspection mechanisms in which at least one of the sigma ratio and focus shift amount of each illumination optical system is different are used and inspection images of the sample 31 may be acquired from the respective inspection mechanisms. Further, in each inspection mechanism, the sigma ratio and focus shift amount of the illumination optical system are made variable and an inspection image of the sample 31 may be acquired by changing at least one of the sigma ratio and focus shift amount.

The nano-imprinting template is formed with a simple structure having a region in which glass is left behind when a chrome film is separated and a portion obtained by etching glass and becomes a phase substance with an optical transmission factor of 100%. Therefore, it becomes necessary to adequately set the sigma ratio and focus shift amount to acquire an inspection image with high contrast. Generally, it is desirable to set the sigma ratio to 0.1 to 0.5 and adequately set the focus shift amount according to the defect type.

It is not always necessary to provide a plurality of inspection mechanisms as the inspection unit 10 and the optical condition of one inspection mechanism may be changed to inspect the same sample. In the inspection mechanism of FIG. 2, for example, the focus is changed to set three focus conditions of a front focus, exactly in focus and rear focus. As a result, even when one apparatus is used, the apparatus can be used as a plurality of inspection mechanisms 11 to 13.

The determination unit 20 includes a plurality of edge extraction circuits 21 to 23 to which a plurality of inspection images are input from the inspection unit 10, and a defect determination circuit 25 that determines the presence or absence of a pattern defect based on outputs of the edge extraction circuits 21 to 23. The edge extraction circuits 21 to 23 emphasize variations in gray levels of input inspection images to acquire edge images. The defect determination circuit 25 determines whether or not the threshold values previously set for the respective edge images from the edge extraction circuits 21 to 23 are exceeded. When it is determined that at least one of the threshold values of the edge images is exceeded, it is determined that the defect is present in the pattern and defect information is output.

Next, the defect determination operation in the present embodiment is explained.

Plural inspection images acquired in the inspection unit 10 are processed in the respective edge extraction circuits 21 to 23 and the edges of the patterns in the inspection images are extracted. Then, the edges are input to the defect determination circuit 25, the presence or absence of a defect is determined and defect information is output if the defect is present. In this case, the inspection images are obtained by photographing repetitive fine patterns with the resolution limit or less in the optical system of the inspection mechanism. The resolution limit is defined as follows when, for example, the pitch of the line & space is P, the inspection wavelength is λ and the numerical aperture is NA.

P=0.61×λ/NA

In this embodiment, an object in a range of P<<0.61×λ/NA or less is to be inspected. The nano-imprinting master template and the replica thereof are formed to have the line & space with the above resolution limit or less and are not resolved by optical inspection by means of an inspection mechanism.

Further, a plurality of inspection images are configured by images obtained and collected while the optical condition is changed. In this case, the inspection image is not limited to a UV optical image used for a semiconductor inspection and may be an SEM image of low resolution. The difference in the optical condition may be obtained by transmission illumination or reflection illumination, or a bright-field optical system or dark-field optical system, for example. Further, an optical system in which sigma ratios and focus shift amounts of different illumination optical systems are set or an illumination optical system based on circular polarization or linear polarization may be considered.

Even if the defect is a fatal defect, the defect cannot be detected under a certain optical condition and may be effectively detected under a specified optical condition. Therefore, in the defect determination circuit 25, edges of inspection images obtained under plural optical conditions are inspected and it is determined that a defect is present if even one defect is recognized.

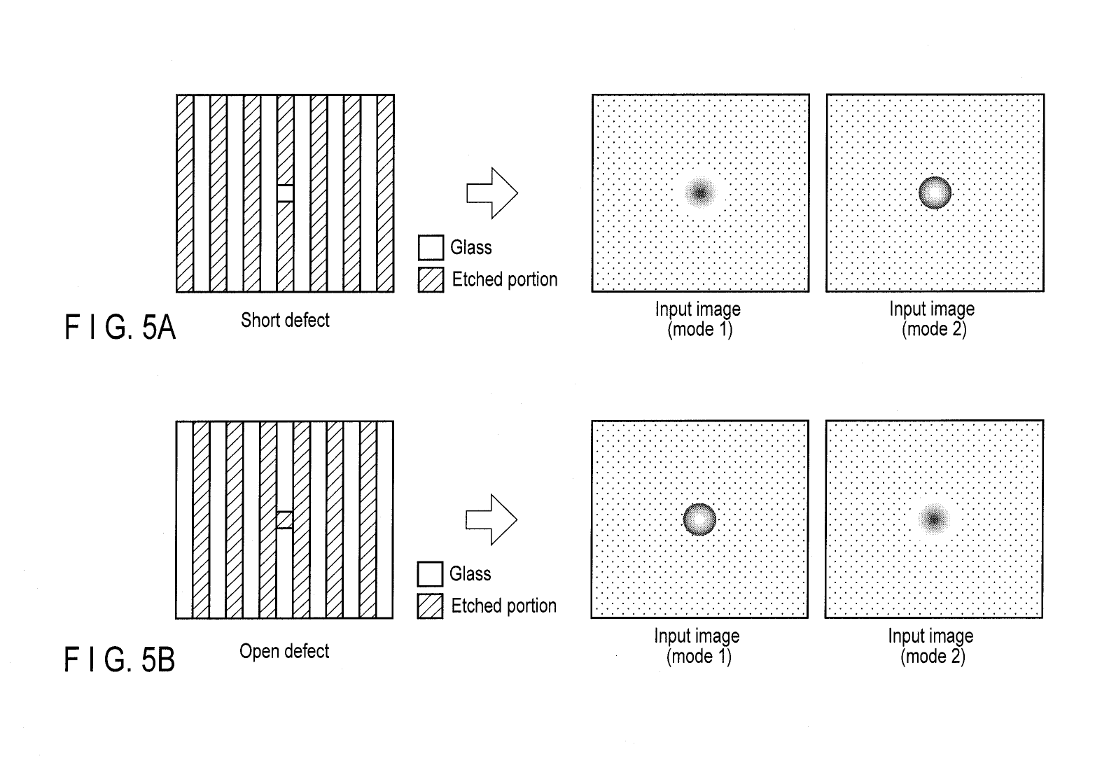

FIGS. 5A, 5B show the relationship between a short defect and an open defect of nano-imprinting templates and input images. FIG. 5A shows the case of the short defect and FIG. 5B shows the case of the open defect. As an example of the input images, two types of images obtained by changing the mode of the illumination system are shown. The images are edge images obtained by processing the inspection images by use of the edge extraction circuit. It is supposed that the transmission illumination optical system is set to (mode 1) and the reflection illumination optical system is set to (mode 2). A template defect is observed as a bright point or dark point as shown in the center of each image. Further, since the line width dimension of the template is set to the optical resolution or less, it is not resolved as the line & space. Instead of this, line width error roughness (LER) or the like is distributed in the form of background noise as a texture image. This makes it difficult to detect a fine short defect or open defect.

For the short defect as shown in FIG. 5A, it is difficult to identify the defect in (mode 1) and it is easy to identify the defect in (mode 2). On the other hand, for the open defect as shown in FIG. 5B, it is easy to identify the defect in (mode 1) and it is difficult to identify the defect in (mode 2). That is, a mode suitable for detecting a defect according to the type of defect is present. Therefore, it becomes possible to stably inspect defects by making inspections in plural modes.

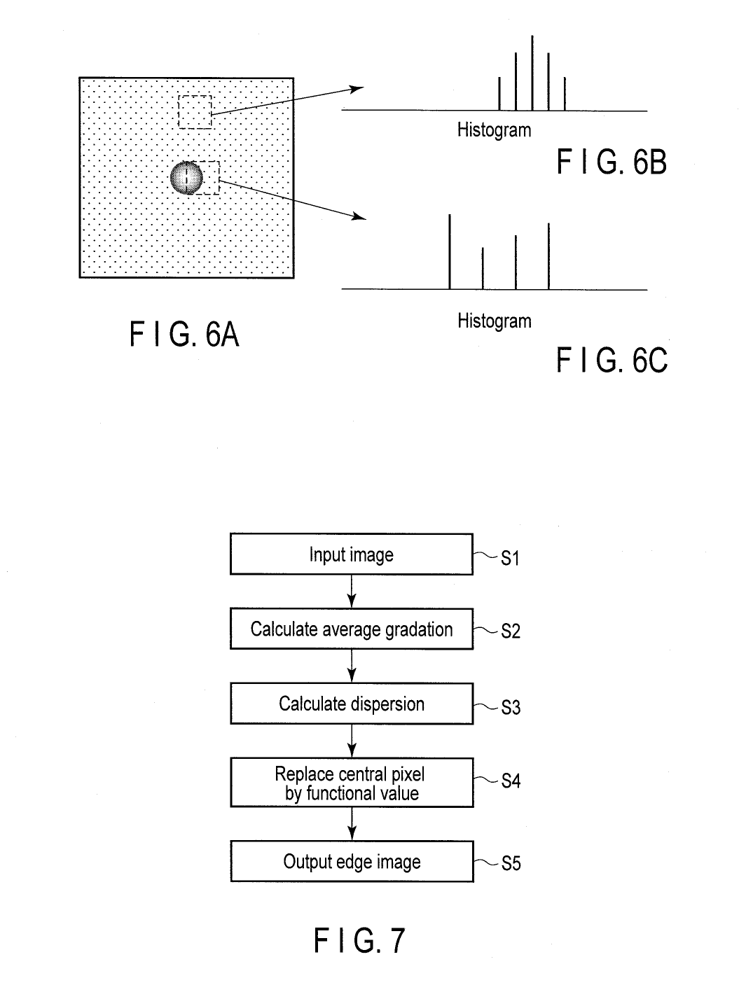

It is understood that a dispersive value on the defective portion becomes larger when comparing the histograms of a gray level in the defective portion (FIG. 6B) and background (FIG. 6C) with respect to an input image (edge image) as shown in FIG. 6A. Therefore, it becomes possible to detect only a defect according to the degree of dispersion.

Thus, according to the present embodiment, the fatal defect of the nano-imprinting template can be rapidly inspected with high sensitivity while permitting base noise by determining a defect in plural inspection images photographed under different optical conditions.

Further, in this embodiment, only a defect can be detected by photographing repetitive fine patterns with the resolution limit of the optical system or less. As a result, occurrence of pseudo-defects that may be caused when a high-resolution image is used can be reduced and a process such as an image alignment process or the like that is conventionally required is not required. Therefore, the apparatus cost can be lowered.

Further, the following effect can be obtained by selecting the inspection mechanisms 11 to 13 (selecting the different optical conditions) in the inspection unit 10.

It is useful to detect an open defect or short defect of the nano-imprinting template, a topological defect of foreign matter or the like by using an optical system in which sigma ratios and focus shift amounts of different illumination optical system are set.

The following effect can be obtained by utilizing the transmission illumination and reflection illumination as the optical conditions. That is, since the nano-imprinting template is transparent, an advantage that the image contrast can be set higher in the reflection optical system can be obtained. It becomes possible to detect opaque foreign matter by simultaneously collecting images from the transmission optical system.

The following effect can be obtained by utilizing an illumination optical system based on circular polarization or linear polarization as the optical condition. That is, the effect of enhancing the defect detection sensitivity can be obtained by changing the polarization condition in the pattern of the line & space or the like.

Normally, bright-field illumination is used, but the effect of suppressing a noise component of the background can be expected by use of dark-field illumination.

### Second Embodiment

FIG. 7 is a flowchart for illustrating the operation of a defect inspection apparatus according to a second embodiment.

The basic configuration of the present embodiment is the same as that of the first embodiment and the processes of the edge extraction circuits 21 to 23 are improved in this embodiment.

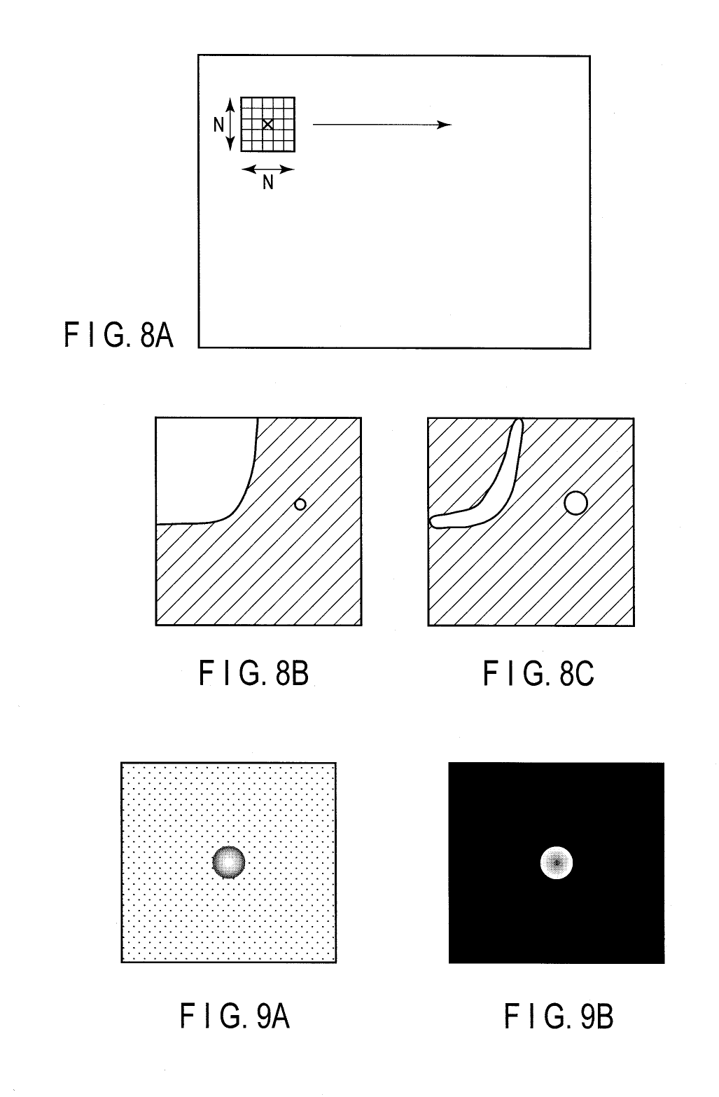

In the edge extraction circuits 21 to 23, after an inspection image is input (step S1), an average gradation value and dispersion in each window region are calculated by scanning a window of size N×N with a target pixel set as a center in the whole image as shown in FIG. 8A (steps S2, S3). Further, a functional value determined according to the average gradation and dispersion is derived and the central image is replaced by the functional value (for example, dispersive value) (step S4). Then, an edge image is extracted based on the central image replaced by the functional value and the thus extracted edge image is output (step S5).

As a result, the input image as shown in FIG. 8B is converted to an edge image as shown in FIG. 8C. That is, an image in which the defective portion becomes large and the edge is emphasized is obtained. Window size N may be enlarged to enhance the calculation precision. Further, window size N may be made small to enhance the space resolution.

To detect a fatal defect while permitting base noise, it is necessary to pay much attention to the statistical variations of them. The base noise does not locally have the specified directivity and a gradation variation between adjacent pixels is relatively small. The fatal defect exhibits the characteristic of a point that is locally bright or dark in comparison with the surrounding pixel and has a vibrational waveform in the peripheral portion of the bright point or dark point and a gradation variation between adjacent pixels becomes large.

Therefore, the average gradation and dispersion are calculated for images in a window (for example, N×N pixels) with the target pixel set as a center and a functional value determined according to the average gradation and dispersion is substituted in the target image. As a result, the defect and base noise can be distinguished.

In this case, the size of the window may be adequately selected by taking the frequency characteristics of the defect and base noise into consideration. As the definition of the function, the following values may be considered.

(Dispersion)

(Dispersion)+(Coefficient)x(Average Gradation)

(Dispersion)+(Coefficient)x(Average Gradation)²

The dispersion has a property that it varies in proportion to the square of the magnitude of line edge roughness caused by the drawing process. In comparison with a method using a space differential filter, the above method does not depend on a specified edge direction and gives a nonlinear effect that the defect can be emphasized while suppressing base noise. Further, the operation of calculating the average gradation and dispersion can easily be performed by use of a logical circuit and computer program. This method is not limited to an optical inspection and can be applied to an inspection using images of low contrast by means of an electron-beam scanning microscope utilizing a large amount of charges.

FIGS. 9A, 9B show images obtained before and after the process obtained by applying the above filter to an inspection image. It is understood that an image defect can be more clearly extracted in the image after application of the filter shown in FIG. 9B rather than the image before application of the filter shown in FIG. 9A.

Thus, in this embodiment, a defect signal can be emphasized and base noise can be reduced by applying the statistical space filter in addition to the first embodiment when the nano-imprinting template is optically inspected. Therefore, only the fatal defect can be more effectively detected. Further, in this embodiment, a stable signal can be obtained irrespective of the direction of the pattern.

### Third Embodiment

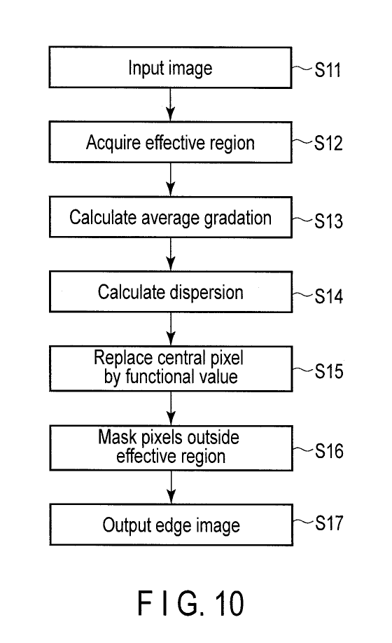

FIG. 10 is a flowchart for illustrating the operation of a defect inspection apparatus according to a third embodiment.

The basic configuration of the apparatus is the same as that of the first embodiment and the processes in the edge extraction circuits 21 to 23 are improved in this embodiment.

In the edge extraction circuits 21 to 23, after an inspection image is input (step S11), an effective region used for making a defect inspection is set (step S12). Then, a window of size N×N is scanned in the whole image and an average gradation value and dispersion in each window region are calculated (steps S13, S14). Further, a functional value determined according to the average gradation and dispersion is derived and the central image is replaced by the functional value (step S15). Then, pixels outside the effective region are masked (step S16). In this state, an edge image is extracted based on the central image replaced by the functional value and the thus extracted edge image is output (step S17).

The method described in the second embodiment has no problem in the case of repetitive patterns of the line & space, for example. However, since the difference between brightness and darkness becomes larger in the peripheral region of the chip, for example, this difference causes erroneous detection. In such a case, a method for recognizing the peripheral pattern and suppressing defect detection is considered in addition to a method for previously limiting and specifying an inspection region. As the method for recognizing the peripheral pattern, it is effective to detect the maximum gradation of a window and determine whether or not the threshold value is exceeded since the gradation of the peripheral pattern becomes larger than the gradation of the line & space. Further, if the peripheral pattern is large enough to be resolved, it is considered to make an inspection by use of the conventional die-to-die comparison or die-to-database comparison method.

In this embodiment, the peripheral pattern is eliminated from the defect inspection by masking pixels outside the effective region after the edge image is extracted as in the second embodiment. As a result, erroneous detection of the defect inspection is prevented. In this case, the effective region is defined by a region of repetitive patterns with the minute dimension that is less than or equal to the resolution of the inspection optical system. The peripheral pattern is a region of patterns with the large dimension to be resolved by the inspection optical system. Therefore, if the mask process is not performed, there occurs a possibility that a defect may be erroneously detected in the inspection region close to the peripheral pattern. The mask process can be performed by inputting attribute data indicating the inspection region and suppressing detection in a non-inspection region.

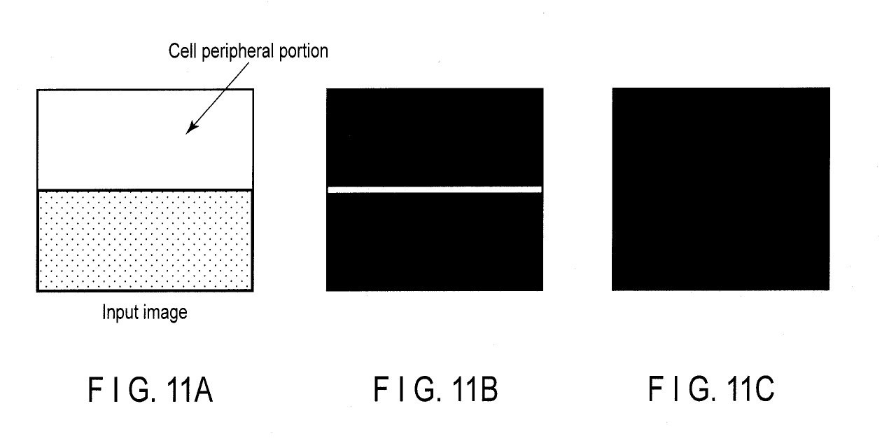

As shown in FIGS. 11A to 11C, it is understood that the effect of preventing erroneous detection by eliminating the peripheral pattern is provided. If the mask process is not performed with respect to an input image shown in FIG. 11A, an edge portion is detected and this portion may be erroneously detected as a defect as shown in FIG. 11B. On the other hand, if the mask process is performed, an edge portion is not detected and erroneous detection can be previously prevented as shown in FIG. 11C.

Thus, according to this embodiment, the same effect as that of the second embodiment can be obtained and occurrence of a pseudo-defect due to the peripheral pattern outside the inspection region can be suppressed.

(Modification)

This invention is not limited to the above embodiments.

The inspection mechanisms with the different optical conditions are not necessarily limited to the types of mechanisms described in the above embodiments and various types of inspection mechanisms can be applied. Further, the number of inspection mechanisms with the different optical conditions is not limited and it is sufficient if plural inspection mechanisms are provided. In addition, even when only one inspection mechanism is used, the inspection mechanism can be used instead of the plural inspection mechanisms if the configuration thereof is made to easily change the optical conditions.

Further, in the embodiments, the defect inspection for the nano-imprinting template is explained, for example, but the defect inspection is not limited to this case and can be applied to various types of mask defect inspections. Additionally, the defect inspection can be applied to an inspection for a sample having a pattern with the resolution limit of the inspection mechanism or less.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A defect inspection apparatus comprising:
an inspection unit configured to acquire a plurality of inspection images by photographing repetitive patterns of not larger than a resolution limit of an optical system under different optical conditions with respect to a to-be-inspected sample,
an edge image extraction unit configured to respectively extract edge images from the plural inspection images, and
a defect determination unit configured to determine the presence of a defect of the pattern based on the plural edge images.

2. The apparatus according to claim 1, wherein the inspection unit includes a plurality of inspection mechanisms in which at least one of sigma ratios and focus shift amounts of illumination optical systems is different and acquires the inspection images from the plural inspection mechanisms.

3. The apparatus according to claim 1, wherein the inspection unit includes one inspection mechanism in which both of a sigma ratio and focus shift amount of an illumination optical system are variable and changes at least one of the sigma ratio and focus shift amount to acquire the plural inspection images.

4. The apparatus according to claim 1, wherein the inspection unit includes a transmission illumination inspection mechanism and reflection illumination inspection mechanism and acquires the inspection images from the respective inspection mechanisms.

5. The apparatus according to claim 1, wherein the inspection unit includes an inspection mechanism of a circular polarization illumination optical system and an inspection mechanism of a linear polarization illumination optical system and acquires the inspection images from the respective inspection mechanisms.

6. The apparatus according to claim 1, wherein the inspection unit includes an inspection mechanism of a bright-field optical system and an inspection mechanism of a dark-field optical system and acquires the inspection images from the respective inspection mechanisms.

7. The apparatus according to claim 1, wherein the edge image extraction unit extracts an edge image in which a variation in a gray level of the inspection image is emphasized.

8. The apparatus according to claim 1, wherein the edge image extraction unit calculates an average gradation value and dispersion of a window having N pixels×N pixels with a pixel set as a center for each pixel of the inspection image, substitutes a functional value determined according to the average gradation value and dispersion into a central pixel and extracts the edge image based on the central image replaced by the functional value.

9. The apparatus according to claim 8, wherein the edge image extraction unit masks a region in which a maximum gradation value of the window with the pixel set as a center for each pixel of the inspection image has exceeded a threshold value instead of substituting the functional value.

10. The apparatus according to claim 1, wherein the defect determination unit determines the presence of a defect with respect to the respective plural edge images and determines the presence of a defect when a defect is recognized in at least one of the plural edge images.

11. A defect inspection apparatus comprising:
an inspection unit configured to acquire a plurality of inspection images by photographing repetitive patterns of not larger than a resolution limit of an optical system under different optical conditions with respect to a nano-imprinting template having the repetitive patterns formed thereon,
an edge image extraction unit configured to extract edge images in which variations in a gray level are emphasized from the plural inspection images, and
a defect determination unit configured to determine the presence of a defect of the pattern based on the plural edge images.

12. The apparatus according to claim 11, wherein the inspection unit includes a plurality of inspection mechanisms in which at least one of a sigma ratio and focus shift amount of an illumination optical system is different and acquires the inspection images from the plural inspection mechanisms.

13. The apparatus according to claim 11, wherein the inspection unit includes one inspection mechanism in which both of a sigma ratio and focus shift amount of an illumination optical system are variable and changes at least one of the sigma ratio and focus shift amount to acquire the plural inspection images.

14. The apparatus according to claim 11, wherein the inspection unit includes a transmission illumination inspection mechanism and reflection illumination inspection mechanism and acquires the inspection images from the respective inspection mechanisms.

15. The apparatus according to claim 11, wherein the inspection unit includes an inspection mechanism of a circular polarization illumination optical system and an inspection mechanism of a linear polarization illumination optical system and acquires the inspection images from the respective inspection mechanisms.

16. The apparatus according to claim 11, wherein the inspection unit includes an inspection mechanism of a bright-field optical system and an inspection mechanism of a dark-field optical system and acquires the inspection images from the respective inspection mechanisms.

17. The apparatus according to claim 11, wherein the edge image extraction unit calculates an average gradation value and dispersion of a window having N pixels×N pixels with a pixel set as a center for each pixel of the inspection image, substitutes a functional value determined according to the average gradation value and dispersion into a central pixel and extracts the edge image based on the central image replaced by the functional value.

18. The apparatus according to claim 17, wherein the edge image extraction unit masks a region in which a maximum gradation value of the window with the pixel set as a center for each pixel of the inspection image has exceeded a threshold value instead of substituting the functional value.

19. The apparatus according to claim 11, wherein the defect determination unit determines the presence of a defect with respect to the respective plural edge images and determines the presence of a defect when a defect is recognized in at least one of the plural edge images.

20. A defect inspection apparatus comprising:
an inspection unit configured to acquire a plurality of inspection images by photographing repetitive patterns of not larger than a resolution limit of an optical system under different optical conditions in which at least one of a sigma ratio and focus shift amount of an illumination optical system is changed with respect to a to-be-inspected sample,
an edge image extraction unit configured to respectively extract edge images from the plural inspection images by calculating an average gradation value and dispersion of a window with a pixel set as a center for each pixel of the inspection image, substituting a functional value determined according to the average gradation value and dispersion into a central pixel, extracting an edge image based on the central image replaced by the functional value and masking a region in which a maximum gradation value of the window has exceeded a threshold value instead of substituting the functional value, and
a defect determination unit configured to determine the presence of a defect of the pattern based on the plural edge images.
